(19) United States
(12) Patent Application Publication
(10) Pub. No.: US 2026/0268189 A1
(43) Pub. Date: Sep. 10, 2026

(54) INTEGRATED PULSE OPTIMIZER AND SIMULATOR FOR HIGH-FIDELITY TWO-QUBIT GATES ON TRAPPED IONS

(71) Applicant: DUKE UNIVERSITY, Durham, NC (US)

(72) Inventors: Kenneth BROWN, Durham, NC (US); Mingyu KANG, Durham, NC (US); Qiyao LIANG, Durham, NC (US); Shilin HUANG, Durham, NC (US); Bichen ZHANG, Durham, NC (US); Leon RIESEBOS, Durham, NC (US)

(21) Appl. No.: 19/165,948

(22) PCT Filed: Apr. 17, 2024
(86) PCT No.: PCT/US2024/024961

§ 371 Date: Sep. 16, 2025

Related U.S. Application Data
(60) Provisional application No. 63/459,766, filed on Apr. 17, 2023.

(51) Int. Cl. G06N 10/20

(52) U.S. Cl. CPC G06N 10/20

(57) ABSTRACT

Technologies for simulating and optimizing electromagnetic pulses are disclosed herein. A quantum computing system generates, based on a specification of one or more system parameters, one or more control values, and one or more noise offsets, a controlled environment for a quantum computing system. The quantum computing system simulates, as a function of the control values, one or more pulses within the controlled environment. One or more candidate pulses are identified based on an evaluation of the simulated pulses. A sequence comprising properties of at least one of the candidate pulses is returned.

### CROSS-REFERENCE TO RELATED APPLICATIONS

This application claims the benefit of priority from U.S. Provisional Application No. 63/459,766, entitled “SYSTEM AND METHOD FOR FILTERING FREQUENCY-MODULATED PULSES FOR HIGH-FIDELITY TWO-QUBIT GATES,” filed Apr. 17, 2023, the disclosure of which is hereby incorporated by reference herein in its entirety.

### GOVERNMENT LICENSE RIGHTS

This invention was made with government support under IARPA through ARO Contract W911NF-16-1-0082, the National Science Foundation Expeditions in Computing Award 1730104, the National Science Foundation STAQ Project Phy-181191. The government has certain rights in the invention.

### FIELD

The present disclosure generally relates to quantum computing, and more specifically to techniques for designing, simulating, and optimizing electromagnetic pulses in a quantum computing system.

### BACKGROUND

Electromagnetic pulses serve numerous functions in quantum computing. For instance, a quantum computer uses electromagnetic pulses to drive operations for controlling and manipulating qubits. Properties associated with an electromagnetic pulse, such as frequency, amplitude, and phase, are configured in a way to effect specific qubit behavior within the quantum computer, such as for entanglement and other gate operations. Therefore, the way in which pulse properties are configured is closely linked to the overall quality of performance and reliability of the quantum computer.

### SUMMARY

Embodiments presented herein disclose techniques for simulating and optimizing pulses for a quantum computing system. For example, one embodiment discloses a method that generally includes generating, based on a specification of one or more system parameters, one or more control values, and one or more noise offsets, a controlled environment for a quantum computing system. The method also generally includes simulating, as a function of the control values, one or more pulses within the controlled environment. The method also generally includes identifying, based on an evaluation of the simulated pulses, one or more candidate pulses.

Another embodiment presented herein discloses a computer-readable storage medium storing a plurality of instructions, which when executed by one or more processors, causes a quantum computing system to generate, based on a specification of one or more system parameters, one or more control values, and one or more noise offsets, a controlled environment for a quantum computing system. One or more pulses within the controlled environment are simulated as a function of the control values. Based on an evaluation of the simulated pulses, one or more candidate pulses are identified. A sequence comprising properties of at least one of the one or more candidate pulses is returned.

Yet another embodiment presented herein discloses a quantum computing system having one or more processors and a memory storing a plurality of instructions, which when executed by the one or more processors, causes a quantum computing system to generate, based on a specification of one or more system parameters, one or more control values, and one or more noise offsets, a controlled environment for a quantum computing system. One or more pulses within the controlled environment are simulated as a function of the control values. Based on an evaluation of the simulated pulses, one or more candidate pulses are identified. A sequence comprising properties of at least one of the one or more candidate pulses is returned.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a partial view of an example ion trap quantum computer configured to generate frequency-modulated two-qubit gates, according to an embodiment;

FIG. 2 is a schematic view of an ion trap for confining ions in a chain, according to an embodiment;

FIG. 3 is a schematic energy diagram of each ion in a chain of trapped ions, according to an embodiment;

FIG. 4 is a qubit state of an ion represented as a point on a surface of the Bloch sphere, according to an embodiment;

FIG. 5 is a flow diagram of an example method for designing, simulating, and optimizing pulses for a quantum computing system; and

FIG. 6 is a flow diagram of an example method for generating a frequency-modulated two-qubit gate.

### DETAILED DESCRIPTION

Electromagnetic pulse design typically involves tailoring pulses to specific use cases and constraints. For example, for gate operations, properties such as pulse shape, duration, frequency, and amplitude will differ in implementing a single-qubit gate in contrast to implementing a two-qubit gate. In addition, quantum algorithms generally require sequences of different pulses. Pulses are also susceptible to error caused by noise, crosstalk, and other environmental or system conditions, and therefore, effective design will take these conditions in account. Testing and optimizing electromagnetic pulses for specific situations prior to deployment is therefore desirable.

Embodiments of the present disclosure provide techniques for designing, simulating, and optimizing electromagnetic pulses, such as frequency-modulated (FM) laser pulses, for use in a quantum computing system, such as a trapped ion computer. More specifically, the present disclosure provides a software framework that enables the simulation of electromagnetic pulses subject to specified inputs, such as control parameters, pulse properties, and environmental and system conditions. The framework provides multiple simulation models allowing the quantum computing system to simulate the pulses within a environment that is also generated according to the specified inputs. The simulation models provide environments that allow candidate electromagnetic pulses for a given use case to be identified and optimized. For example, using the simulation models, the quantum computing system may treat candidate FM pulses and time-varying noise as phase, which creates efficiency and also provides a realistic simulation.

Further, the software framework of the present disclosure may incorporate optimization techniques that achieve robust performance adverse conditions, such as static and time-varying noise that may be encountered in the quantum computing system. For example, the optimization techniques described herein may adopt filter function design methods for FM laser pulses to ensure high-fidelity two-qubit gates in ion chains. More specifically, in quantum computing, fidelity pertains to a measure of how close a final quantum state of a real-life qubits matches the ideal case, or more particularly, the probability that one state will pass a test to identify as the other. Gate fidelity refers to how close a quantum gate is to another quantum gate. Generating high-fidelity entangling gates in multi-qubit systems is a known issue in quantum computing. As the amount of qubits scale in a quantum computing system, noise and parameter drift can potentially cause a drop in fidelity for two-qubit gates. Generally, trapped-ion qubits are entangled by a state-dependent force that briefly excites normal modes of the collective motion of the ions. At the end of the gate, all motional modes should be completely disentangled with each other by the correct amount. Filter function (FF) formalism enables characterization of the susceptibility to noise of a quantum computing system during a control operation and describes the performance of the control operation in the presence of time-varying noise.

The software framework may generate, optimize, and apply FFs of FM pulses for two-qubit gates that accurately predict the change in gate error caused by small parameter fluctuations at any frequency, such that the effects of noise of a given spectrum are suppressed. Further, through the framework, FF design that accounts for fluctuations in a variety of time-varying parameters is achievable.

Advantageously, the embodiments of the present disclosure, in addition to accounting for static offsets in motional-mode frequencies similar to the pulse-design methods of previous approaches, allow for the creation of electromagnetic pulses that to be used in operations that achieve lower gate error given the presence of adverse environmental and system influences such as time-varying fluctuations in parameters. As a result, the FM two-qubit gates generated based on such FFs described herein may achieve a higher entangling gate fidelity compared to previous approaches.

Note, the present disclosure uses a trapped ion quantum computer as a reference example quantum computing system that enables the design, simulation, and optimization of electromagnetic pulses via a software framework. However, one of skill in the art will recognize that in addition to trapped ion quantum computers, the embodiments may be adapted to other types of quantum computing systems (e.g., quantum annealing systems, superconductor circuit quantum computers, spin qubit quantum computers, etc.) and so on. Further, the present disclosure describes the software framework enabling design of FM pulses as a reference example of a type of electromagnetic pulse that can be designed, simulated, and optimized. Of course, the embodiments of the present disclosure may be adapted towards other types of pulses, such as amplitude modulated (AM) pulses.

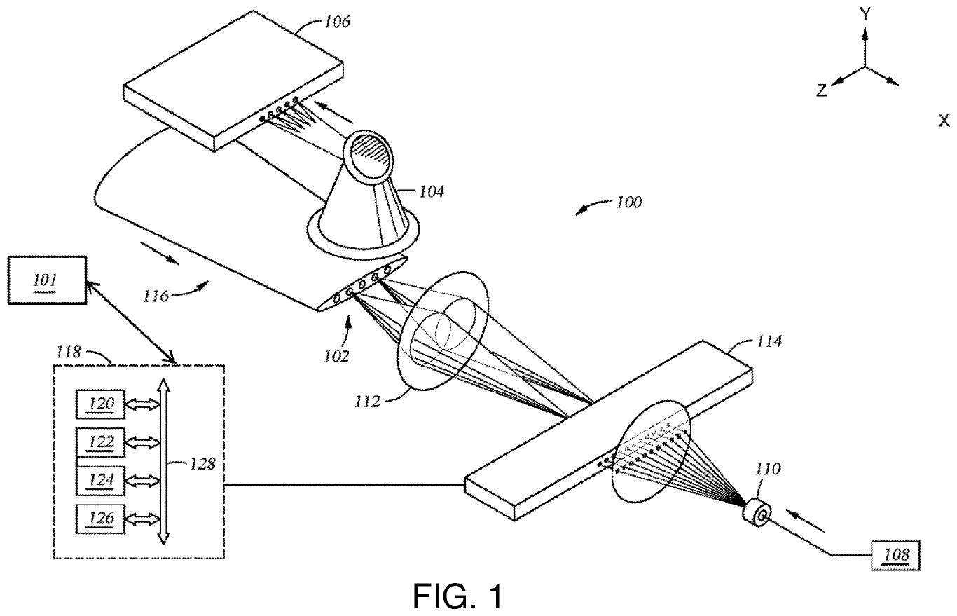

FIG. 1 is a partial view of an example ion trap quantum computer, or system 100, that may implement the software framework for designing, simulating, and optimizing electromagnetic pulses described herein, according to one embodiment. The system 100 includes a classical (digital) computer 101, a system controller 118 and a quantum register that is a chain 102 of trapped ions (i.e., five shown) that extend along the Z-axis.

The classical computer 101 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. The support circuits (not shown) are also connected to the CPU for supporting the processor in a conventional manner. The support circuits may include conventional cache, power supplies, clock circuits, input/output circuitry, subsystems, and the like.

Software instructions, algorithms and data can be coded and stored within the memory for instructing the CPU. For example, the memory may include a software application enabling the design, simulation, and optimization of electromagnetic pulses, such as frequency-modulated (FM) pulses used to drive quantum operations of the system 100. As further described herein, the software application may output the results as a sequence of FM laser pulse properties (e.g., laser frequencies, intensities, and phases to be applied to ions to enact the pulses identified during the simulation and optimization).

An imaging objective 104, such as an objective lens with a numerical aperture (NA), for example, of 0.37, collects fluorescence along the Y-axis from the ions and maps each ion onto a multi-channel photo-multiplier tube (PMT) 106 for measurement of individual ions. Non-copropagating Raman laser beams from a laser 108, which are provided along the X-axis, perform operations on the ions. A diffractive beam splitter 110 creates an array of static Raman beams 112 that are individually switched using a multi-channel acousto-optic modulator (AOM) 114 and is configured to selectively act on individual ions. A global Raman laser beam 116 illuminates all ions at once.

The system controller (also referred to as a “RF controller”) 118 controls the AOM 114. The system controller 118 includes a central processing unit (CPU) 120, a read-only memory (ROM) 122, a random access memory (RAM) 124, a storage unit 126, and the like. The CPU 120 is a processor of the RF controller 118. The ROM 122 stores various programs and the RAM 124 is the working memory for various programs and data. The storage unit 126 includes a nonvolatile memory, such as a hard disk drive (HDD) or a flash memory, and stores various programs even if power is turned off. The CPU 120, the ROM 122, the RAM 124, and the storage unit 126 are interconnected via a bus 128.

The RF controller 118 executes a control program which is stored in the ROM 122 or the storage unit 126 and uses the RAM 124 as a working area. The control program will include software applications that include program code that may be executed by the processor to perform various functionalities associated with receiving and analyzing data and controlling any and all aspects of the methods and hardware used to create the ion trap quantum computer system 100 discussed herein. For example, in an embodiment, the control program may include program code for generating electromagnetic pulses from sequence data returned from the simulation and optimization software discussed herein. The control program may also include program code for generating frequency-modulated two-qubit ion gates, such as program code for measuring a noise power spectral density (PSD) of an ion trap of the system 100, generating one or more filtering functions based on fluctuations associated with the measured noise in time-varying parameters for entangling qubits in the ion trap, applying the one or more filtering functions to identify a pulse measure, and applying pulses to two or more qubits in the ion chain.

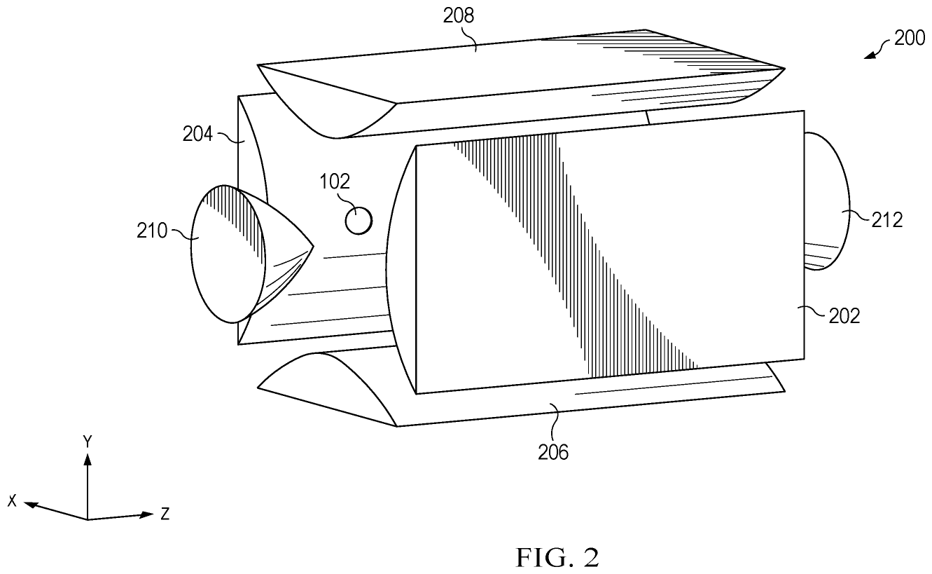

FIG. 2 depicts a schematic view of an ion trap 200 (also referred to as a Paul trap) for confining ions in the chain 102, according to an embodiment. The confining potential is exerted by both static (DC) voltage and radio frequency (RF) voltages. A static (DC) voltage vₛ is applied to end-cap electrodes 210 and 212 to confine the ions along the Z-axis (also referred to as an “axial direction” or a “longitudinal direction”). The ions in the chain 102 are nearly evenly distributed in the axial direction due to the Coulomb interaction between the ions. In some embodiments, the ion trap 200 includes four hyperbolically-shaped electrodes 202, 204, 206, and 208 extending along the Z-axis.

During operation, a sinusoidal voltage V₁ (with an amplitude V_{RF}/2) is applied to an opposing pair of the electrodes 202, 204 and a sinusoidal voltage V₂ with a phase shift of 180° from the sinusoidal voltage V₁ (and the amplitude V_{RF}/2) is applied to the other opposing pair of the electrodes 206, 208 at a driving frequency w̅_{RF}, generating a quadrupole potential. In some embodiments, a sinusoidal voltage is only applied to one opposing pair of the electrodes 202, 204, and the other opposing pair 206, 208 is grounded.

The quadrupole potential creates an effective confining force in the X-Y plane perpendicular to the Z-axis (also referred to as a “radial direction” or “transverse direction”) for each of the trapped ions, which is proportional to a distance from a saddle point (i.e., a position in the axial direction (Z-direction)) at which the RF electric field vanishes. The motion in the radial direction (i.e., direction in the X-Y plane) of each ion is approximated as a harmonic oscillation (referred to as secular motion) with a restoring force towards the saddle point in the radial direction and can be modeled by spring constants kₓ and k_{y}, respectively, as is discussed in greater detail below. In some embodiments, the spring constants in the radial direction are modeled as equal when the quadrupole potential is symmetric in the radial direction.

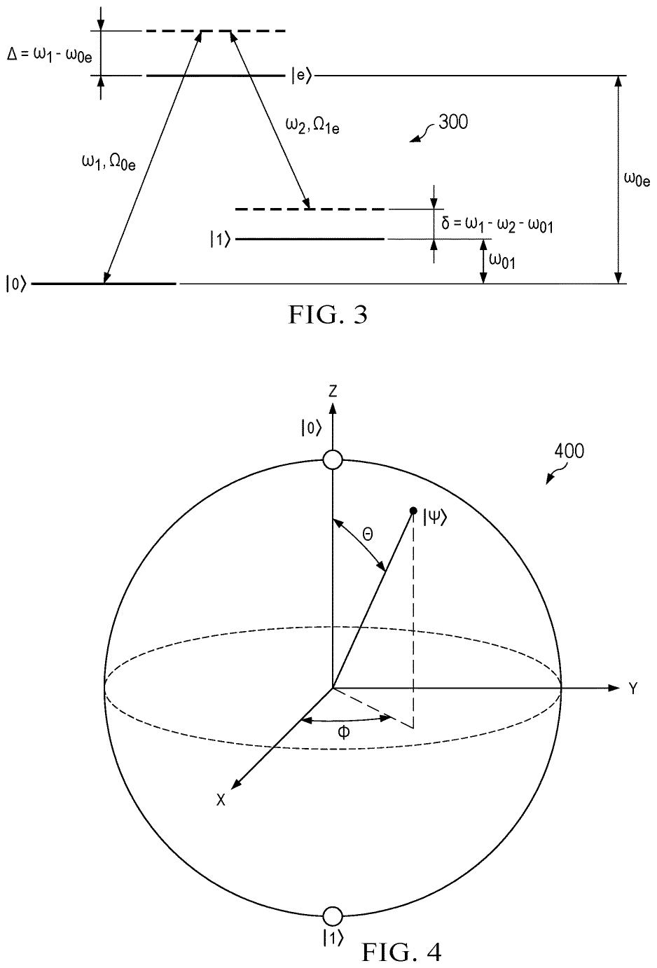

FIG. 3 depicts a schematic energy diagram 300 of each ion in the chain 102 of trapped ions, according to an embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.642821 GHz. A qubit is formed with the two hyperfine states, denoted as |0 [symbol] and |1 [symbol] where the hyperfine ground state (i.e., the lower energy state of the ²S_{1/2} hyperfine states) is chosen to represent |0 [symbol] . Hereinafter, the terms “hyperfine states,” “internal hyperfine states,” and “qubits” may be interchangeably used to represent |0 [symbol] and |1 [symbol] . Each ion may be cooled (i.e., kinetic energy of the ion may be reduced) to near the motional ground state |0 [symbol] ₚ for any motional mode p with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₚ with the subscript p denotes the motional ground state for a motional mode p of a chain 102 of trapped ions.

An individual qubit state of each trapped ion may be manipulated by, for example, a mode-locked laser at 355 nanometers (nm) via the excited ²P_{1/2} level (denoted as |e [symbol] . As shown in FIG. 3, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ, with respect to the transition frequency ω₀ₑ between |0 [symbol] and |e [symbol] , as illustrated in FIG. 3. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁−ω₂−ω₀₁ (hereinafter denoted as +μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀, and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described herein. The detuning frequency δ=ω₁−ω₂−ω₀₁ cool may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be+, Ca+, Sr+, Mg+, and Ba+) or transition metal ions (Zn+, Hg+, Cd+).

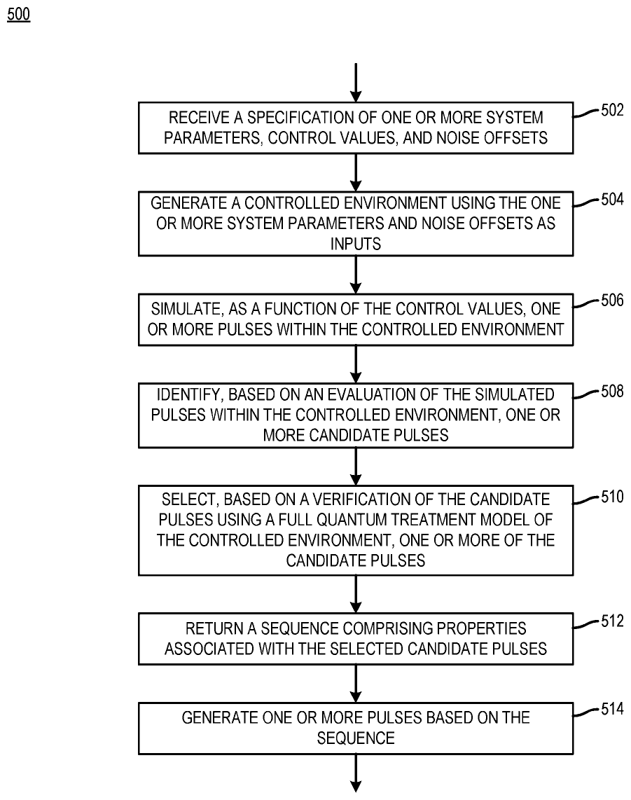

FIG. 4 is provided to help visualize a qubit state of an ion is represented as a point on a surface of the Bloch sphere 400 with an azimuthal angle φ and a polar angle θ. Application of the composite pulse as described above, causes Rabi flopping between the qubit state |0 [symbol] (represented as the north pole of the Bloch sphere) and |1 [symbol] (the south pole of the Bloch sphere) to occur. Adjusting time duration and amplitudes of the composite pulse flips the qubit state from |0 [symbol] to |1 [symbol] (i.e., from the north pole to the south pole of the Bloch sphere), or the qubit state from |1 [symbol] to |0 [symbol] (i.e., from the south pole to the north pole of the Bloch sphere). This application of the composite pulse is referred to as a “π-pulse”. Further, by adjusting time duration and amplitudes of the composite pulse, the qubit state |0 [symbol] may be transformed to a superposition state |0 [symbol] +|1 [symbol] , where the two qubit states |0 [symbol] and |1 [symbol] are added and equally-weighted in-phase (a normalization factor of the superposition state is omitted hereinafter without loss of generality) and the qubit state |1 [symbol] to a superposition state |0 [symbol] −|1 [symbol] , where the two qubit states |0 [symbol] and |1 [symbol] are added equally-weighted but out of phase. This application of the composite pulse is referred to as a “π/2-pulse”. More generally, a superposition of the two qubits states |0 [symbol] and |1 [symbol] that are added and equally-weighted is represented by a point that lies on the equator of the Bloch sphere. For example, the superposition states |0 [symbol] +|1 [symbol] correspond to points on the equator with the azimuthal angle φ being zero and π, respectively. The superposition states that correspond to points on the equator with the azimuthal angle φ are denoted as |0 [symbol] +e^{iφ}|1 [symbol] (e.g., |0 [symbol] ±i|1) for φ=±π/2). Transformation between two points on the equator (i.e., a rotation about the Z-axis on the Bloch sphere) can be implemented by shifting phases of the composite pulse.

In an ion trap quantum computer, the motional modes may act as a data bus to mediate entanglement between two qubits and this entanglement is used to perform an XX gate operation. That is, each of the two qubits is entangled with the motional modes, and then the entanglement is transferred to an entanglement between the two qubits by using motional sideband excitations.

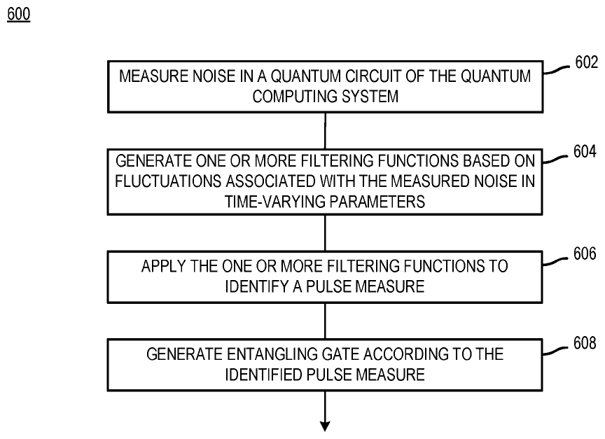

As stated, the classical computer 101 may execute a software application that serves as an integrated pulse optimizer and simulator that can efficiently generate FM pulses for controlling ions within the system 100. Referring now to FIG. 5, the software application (via the classical computer 101), in operation, performs a method 500 for designing, simulating, and optimizing pulses for controlling ions within the system 100. As shown, the method 500 begins in block 502, in which the application receives a specification (e.g., from a user of the software application) of one or more system parameters, control values, and noise offsets. The control values may correspond to qubit- or ion-dependent parameters for a FM laser pulse. Example control values include laser intensity, laser frequency, laser phase, ion-motion coupling parameters, and the like. Example control values may also include global parameters, such as global parameters. The system parameters and noise offsets are generally directed to conditions for simulating a quantum environment. The system parameters can include limits on control values, limits on rates of change, system configurations, and the like. Noise offsets may include offsets for the system parameters, time-dependent offsets for the system parameters (e.g., described by a time sequence or spectral density such as frequency domain), stochastic errors such as heating rate (changes in motional state), dephasing (changes in ion state), crosstalk (unwanted interaction of ion laser intensity on one ion with another ion).

In block 504, the software application generates a controlled environment using the one or more system parameters and noise offsets as inputs. Through the controlled environment, the software application may generate pulses and obtain data pertaining to the effect of the pulses within the environment. In block 506, the software application simulates, as a function of the control values, one or more pulses within the controlled environment. In an embodiment, the simulation treats motion as a parameterized number. In doing so, the classical computer 101 is able to preserve computing resources (compared to simulating full motional states) in reproducing the pulses. In an embodiment, the software application treats FM pulses and time-varying noise as phase, which enables a more efficient and realistic simulation.

In block 508, the software application identifies, based on an evaluation of the pulses, one or more candidate pulses. For example, the evaluation may comprise observing the influence of the specified noise offsets on the and comparing deviations between predefined settings. During this stage, the software application may execute one or more optimization schemes to address static and time-varying noise within the simulated environment. The optimization schemes are discussed in more detail relative to FIG. 6.

In block 510, the software application selects one or more of the candidate pulses based on a verification of the candidate pulses to identify viable pulses for use in a desired quantum operation (defined in part by the system parameters, control values, and noise offsets). The verification may include generating a controlled environment in which the candidate pulses are simulated under a full treatment of possible quantum states. Doing so is more computationally expensive compared to the initial identification of candidate pulses (in which the controlled environment is configured to treat motion as a parameterized number), but in this scenario, the subset of candidate pulses may be considerably smaller than from the outset.

In block 512, the software application returns a sequence comprising properties associated with the selected candidate pulses. The properties can include laser frequencies, intensities, and phases to be applied to ions to enact the selected pulses. In block 514, the software application may cause the control program to generate one or more pulses based on the sequence. The pulses may be implemented through a variety of means in the system 100. For example, the pulses can be implemented using direct digital synthesizers, arbitrary waveform generators, RF systems on chip, and the like.

A variety of user interfaces may be used to provide simulation and optimization by the software application. For example, a command line interface for providing inputs may be used, and the outputs may be provided as a text-based file (e.g., in a comma-separated value (CSV) format) or automatically output to the control program. As another example, a graphical user interface (GUI) may be provided in which parameters may be configured in a menu-based fashion, e.g., by widgets such as sliders, text inputs, drop-down menus, etc. As yet another example, the software application may provide a GUI that allows visualization (e.g., graph visualizations) of parameters, simulations, and outputs.

In an embodiment, the control program includes program code for generating frequency-modulated (FM) two-qubit gates based on filter functions generated by the integrated optimizer and simulator software application. The filter functions are able to accurately predict and account for small fluctuations in time-varying parameters, such as motional-mode frequencies, laser phase, laser intensity. In the system 100, a Mølmer-Sorensen (MS) gate using a FM pulse applies a state dependent force with lasers 108 at a drive frequency modulated near the sideband frequencies. As the pulse is applied to ions j₁ and j₂, the unitary evolution of the system of the ions and the motional modes is

$$\hat{U} = exp \{ {\sum }_{j = {j}_{1} {j}_{2}} {\sum }_{k} ( [ {α}_{kj} {\hat{α}}_{k}^{†} - {α}_{kj}^{*} {\hat{α}}_{k} ] {\hat{σ}}_{j}^{x} ) + i Θ {\hat{σ}}_{{j}_{1}}^{x} {\hat{σ}}_{{j}_{2}}^{x} \} ,$$

in which

$${\hat{α}}_{k}^{†}$$

is the creation operator of mode k and

$${\hat{σ}}_{j}^{x}$$

is the bit-flip operator of ion j. Also, αₖⱼ is the displacement of motional mode k with respect to ion j and Θ is the rotation angle of the spins with respect to the XX axis, which can be represented as

$${α}_{kj} = \frac{{Ωη}_{kj}}{2} {\int }_{0}^{τ} {e}^{- i θ k ( t )} dt ,$$

$$Θ = - {Ω}^{2} {\sum }_{k} \frac{{η}_{{kj}_{1}} {η}_{{kj}_{2}}}{2} {\int }_{0}^{τ} {dt}_{1} {\int }_{0}^{{t}_{1}} {dt}_{2} sin [ θ k ( {t}_{1} ) - {θ}_{k} ( {t}_{2} ) ] ,$$

in which τ is the pulse length, Ω is the carrier Rabi frequency, and ηₖⱼ is the Lambe-Dicke parameter of ion j with respect to mode k. Also,

$${θ}_{k} ( t ) = {\int }_{0}^{t} [ μ ( {t}^{′} ) - {ω}_{k} ] {dt}^{′}$$

is the phase of mode k, where μ(t) is the drive frequency of the pulse and ωₖ is the frequency of mode k.

Static offsets and time-varying fluctuations of mode frequencies ωₖ may occur from various classical sources of noise, such as fluctuation of the rf driving signal for the ion trap 200 and motional dephasing. An ideal MS gate satisfies

$${α}_{{kj}_{1}} = {α}_{{kj}_{2}} = 0 ∀ k and Θ = \frac{π}{4} ,$$

where the first condition is used to completely disentangle the qubits from the motional mode's at the conclusion of the MS gate. At zero temperature and up to leading order, the two-qubit error ε becomes ε=ε_{α}+ε_{θ}, in which ε_{α} and ε_{θ}, respectively, the displacement and angle error, which may be expressed as

$${ε}_{α} = {\sum }_{k} ( {\vert {α}_{{kj}_{1}} \vert}^{2} + {\vert {α}_{{kj}_{2}} \vert}^{2} ) ,$$

$${ε}_{Θ} = {( Θ - \frac{π}{4} )}^{2} .$$

Previous approaches to FM pulse design and optimization (also referred to herein as “robust FM”) identify pulses that are robust to static offsets of mode frequencies. In an embodiment, the system 100 (e.g., using the software application) may apply robustness to time-varying mode-frequency fluctuation δₖ(t) using FF formalism techniques. For instance, assume that δₖ(t)=rₖδ(t)∀k, or more particularly, that fluctuations of different modes differ only up to proportionality constants, in which, for example, δₖ(t) comes from noise in the rf voltage of the ion trap of system 100. When

$$\vert {\int }_{0}^{t} {δ}_{k} ( {t}^{′} ) {dt}^{′} \vert ≪ 1 ( 0 \leq t \leq τ ) ,$$

up to leading order, the two-qubit gate-error terms εᵥ=(v=α, Θ) when ωₖ+rₖδ(t) are given by

$${ε}_{v} = {\int }_{- ∞}^{∞} df \frac{{s}_{δ} ( f )}{{f}^{2}} {F}_{v} ( f ) ,$$

where

$${F}_{α} ( f ) = {Ω}^{2} {\sum }_{k} ( {η}_{{kj}_{1}}^{2} + {η}_{{kj}_{2}}^{2} ) {\vert \frac{{r}_{k}}{2} {\int }_{0}^{τ} {dte}^{i ( 2 π ft - θ} \vert}^{2}$$

$${F}_{Θ} ( f ) = {Ω}^{4} {\vert {\int }_{0}^{τ} {dt}_{1} {\int }_{0}^{{t}_{1}} {dt}_{2} ( {e}^{2 π {ift}_{1}} - {e}^{2 π {ift}_{2}} ) \times {\sum }_{k} \frac{{r}_{k}^{2}}{2} {η}_{{kj}_{1}} {η}_{{kj}_{2}} cos [ {θ}_{k} ( {t}_{1} ) - {θ}_{k} ( {t}_{2} ) \vert}^{2} .$$

S_{δ}(f) represents the power spectral density (PSD) of δ(t), and F_{α}(f) and F_{θ}(f) are FFs for the displacement and angle error, respectively. At frequencies f<<1/τ, F_{θ}(f) is larger than F_{α}(f), which the system 100, in an embodiment, may leverage to minimize gate error given low-frequency noise. In an embodiment, FF optimization may used for a variety of noise PSD. For instance, the software application may identify a drive frequency μ(t) that minimizes cost function

$$C = {\sum }_{k} ( {\vert {\overline{α}}_{{kj}_{1}} \vert}^{2} + {\vert {\overline{α}}_{{kj}_{2}} \vert}^{2} ) + {\sum }_{m = 1}^{M} {\sum }_{v = α , Θ} {w}_{v} ( {f}_{m} ) ( {F}_{v} ( {f}_{m} ) + {F}_{v} ( - {f}_{m} ) ) ,$$

where wᵥ(f) is the weight of FF suppression at selected frequencies f=f₁, . . . , f_{M}.

In an embodiment, the software application may use FFs generated according to the techniques described herein to achieve robustness to time-varying fluctuations in motional-mode frequencies. In an embodiment, the software application may use such FFs to achieve robustness to time-varying fluctuations in the laser phase. For MS gates that use Raman beam pairs, the software application may define motion phase and spin phase from phase differences of the beams. Depending on the orientation of the lasers, the software application may select either motion phase or spin phase to be insensitive to beam-path fluctuations. For instance, in an embodiment, the software application may apply a phase-insensitive method, in which the spin phase is insensitive and the fluctuation of motion phase is denoted as Ø(t).

The motion-phase fluctuation of the lasers Ø(t) directly adds to the phases of the motional modes, or more particularly, θₖ(t)→θₖ(t)+Ø(t)∀k. The system 100 may inject monotone fluctuation having frequency f′ into the motion phase of the lasers and then apply a pulse identified through the FF optimization techniques herein. Doing so should result in the pulse having a reduced gate error measure and any noise of frequency lower than 17 kHz. Advantageously, the system 100 is able to achieve robustness to fluctuations in mode frequencies and those in the motion phase of the lasers simultaneously.

In an embodiment, the system 100 may use FFs generated by the software application to time-varying laser-intensity fluctuations, e.g., manifested as fluctuations in the carrier Rabi frequency. In such a case, assume that Ω′(t) is the unintended fluctuations in Ω→Ω+Ω′(t). Consequently, the MS-gate error terms εᵥ=(v=α, Θ) above due to Ω′(t) are given by

$${ε}_{v} = {\int }_{- ∞}^{∞} {dfS}_{{Ω}^{′}} ( f ) {G}_{v} ( f ) ,$$

where

$${G}_{α} ( f ) = {\sum }_{k} ( {η}_{{kj}_{1}}^{2} + {η}_{{kj}_{2}}^{2} ) {\vert \frac{{r}_{k}}{2} {\int }_{0}^{τ} {dte}^{i ( 2 π ft - {θ}_{k} ( t ) )} \vert}^{2} ,$$

$${G}_{Θ} ( f ) = {Ω}^{2} {\vert {\int }_{0}^{τ} {dt}_{1} {\int }_{0}^{{t}_{1}} {dt}_{2} ( {e}^{2 π {ift}_{1}} + {e}^{2 π {ift}_{2}} ) \times {\sum }_{k} \frac{{r}_{k}^{2}}{2} {η}_{{kj}_{1}} {η}_{{kj}_{2}} sin [ {θ}_{k} ( {t}_{1} ) - {θ}_{k} ( {t}_{2} ) ] \vert}^{2}$$

where S_{Ω′}(f) is the PSD of Ω′(t) and G_{α}(f) and G_{θ}(f) are FFs for displacement and angle errors, respectively. In an embodiment, the FFs may also be designed by performing an optimization with a cost function (such as that described above).

In an embodiment, the software application includes logic for addressing crosstalk errors when implementing two-qubit gates in a chain of more than two ions, to address unwanted entanglement between target and spectator ions created by crosstalk impacting fidelity of the Bell state of the target ions. Crosstalk between target ion i and spectator ion j can be quantified as a carrier-Rabi-frequency ratio ϵᵢⱼ=Ωⱼ/Ωᵢ when resonantly driving a single-qubit gate on ion i. The system 100 may measure ϵᵢⱼ to be approximately 1-2% for nearest neighbors due to imperfect optical addressing, mainly caused by aberrations. Due to the coherent nature of crosstalk, crosstalk can be actively canceled by applying single-qubit spin-echo pulses in the middle of the gate(s), reversing the crosstalk interaction during the second half of the MS evolution. For each sequence of 2n+1 (n≥1) concatenated MS gates in the gate-fidelity measurement, the software application may use a crosstalk suppression that applies the echoing pulses on the target ions. Note, a pair of Y gates commutes with a MS gate, so the Y gates would not affect the final state in ideal conditions. The system 100 may apply a single MS gate after the second pair of Y gates to generate the Bell state for the fidelity measurement.

When the frequency of noise is much lower than 1/τ, noise essentially becomes a static parameter offset within the duration of a single gate. In an embodiment, the software application may combine FF optimization techniques with pre-existing pulse-design methods to achieve robustness to static offsets of motional-mode frequencies beyond first order. For example, the software application may combine FF optimization techniques with a batch robust frequency modulation technique which minimizes average gate error over a range of systematic errors. The software application may perform batch optimization for noise PSDs of various characteristic frequencies f_{c}.

Referring now to FIG. 6, the system 100, in operation, may perform a method 600 for generating high-fidelity entangling gates based on filter functions of frequency-modulated pulses. As shown, the method 600 begins in block 602, in which the system 100 measures noise (e.g., a noise PSD) in a quantum circuit of the quantum computing system, which may be observed by the software application. In block 604, the software application generates one or more filtering functions based on fluctuations associated with the measured noise in time-varying parameters, such as motional-mode frequency, laser phase, and laser intensity discussed above. In block 606, the software application applies the one or more filtering functions to identify a pulse measure. In block 608, the system 100 generates an entangling gate according to the identified pulse measure.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

### Examples

Illustrative examples of the technologies disclosed herein are provided below. An embodiment of the technologies may include any one or more, and any combination of, the examples described below.

Example 1 includes a method, comprising generating, based on a specification of one or more system parameters, one or more control values, and one or more noise offsets, a controlled environment for a quantum computing system; simulating, as a function of the control values, one or more pulses within the controlled environment; identifying, based on an evaluation of the simulated pulses, one or more candidate pulses; and returning a sequence comprising properties of at least one of the one or more candidate pulses.

Example 2 includes the subject matter of Example 1, and further including generating, from the returned sequence, the at least one of the one or more candidate pulses within the quantum computing system.

Example 3 includes the subject matter of any of Examples 1 and 2, and wherein the one or more system parameters comprises at least one of a system setting, one or more limits on the control values, and one or more limits on rates of change.

Example 4 includes the subject matter of any of Examples 1-3, and wherein the one or more control values comprises at least one of a laser frequency, laser intensity, laser phase, and ion-motion coupling parameter.

Example 5 includes the subject matter of any of Examples 1-4, and wherein the one or more noise offsets comprises at least one of a system offset, time-dependent offset, stochastic error, dephasing, and crosstalk.

Example 6 includes the subject matter of any of Examples 1-5, and wherein the properties comprises at least one of a laser frequency, intensity, and phase associated with the at least one of the candidate pulses.

Example 7 includes the subject matter of any of Examples 1-6, and wherein the one or more pulses comprises one or more frequency-modulated pulses.

Example 8 includes the subject matter of any of Examples 1-7, and wherein the quantum computing system is an trapped ion quantum computing system.

Example 9 includes a computer-readable storage medium storing a plurality of instructions, which, when executed by one or more processors, causes a quantum computing system to generate, based on a specification of one or more system parameters, one or more control values, and one or more noise offsets, a controlled environment for a quantum computing system; simulate, as a function of the control values, one or more pulses within the controlled environment; identify, based on an evaluation of the simulated pulses, one or more candidate pulses; and return a sequence comprising properties of at least one of the one or more candidate pulses.

Example 10 includes the subject matter of Example 9, and wherein the plurality of instructions, when executed, further causes the quantum computing system to generate, from the returned sequence, the at least one of the one or more candidate pulses within the quantum computing system.

Example 11 includes the subject matter of any of Examples 9 and 10, and wherein the one or more system parameters comprises at least one of a system setting, one or more limits on the control values, and one or more limits on rates of change.

Example 12 includes the subject matter of any of Examples 9-11, and wherein the one or more control values comprises at least one of a laser frequency, laser intensity, laser phase, and ion-motion coupling parameter.

Example 13 includes the subject matter of any of Examples 9-12, and wherein the one or more noise offsets comprises at least one of a system offset, time-dependent offset, stochastic error, dephasing, and crosstalk.

Example 14 includes the subject matter of any of Examples 9-13, and wherein the properties comprises at least one of a laser frequency, intensity, and phase associated with the at least one of the candidate pulses.

Example 15 includes the subject matter of any of Examples 9-14, and wherein the one or more pulses comprises one or more frequency-modulated pulses.

Example 16 includes the subject matter of any of Examples 9-15, and wherein the quantum computing system is an trapped ion quantum computing system.

Example 17 includes a quantum computing system comprising one or more processors, a memory storing a plurality of instructions, which, when executed by the one or more processors, causes the quantum computing system to generate, based on a specification of one or more system parameters, one or more control values, and one or more noise offsets, a controlled environment for a quantum computing system; simulate, as a function of the control values, one or more pulses within the controlled environment; identify, based on an evaluation of the simulated pulses, one or more candidate pulses; and return a sequence comprising properties of at least one of the one or more candidate pulses.

Example 18 includes the subject matter of Example 17, and wherein the one or more system parameters comprises at least one of a system setting, one or more limits on the control values, and one or more limits on rates of change.

Example 19 includes the subject matter of any of Examples 17 and 18, and wherein the one or more control values comprises at least one of a laser frequency, laser intensity, laser phase, and ion-motion coupling parameter.

Example 20 includes the subject matter of any of Examples 17-19, and wherein the one or more noise offsets comprises at least one of a system offset, time-dependent offset, stochastic error, dephasing, and crosstalk.

1. A method, comprising:
generating, based on a specification of one or more system parameters, one or more control values, and one or more noise offsets, a controlled environment for a quantum computing system;
simulating, as a function of the control values, one or more pulses within the controlled environment;
identifying, based on an evaluation of the simulated pulses, one or more candidate pulses; and
returning a sequence comprising properties of at least one of the one or more candidate pulses.

2. The method of claim 1, further comprising:
generating, from the returned sequence, the at least one of the one or more candidate pulses within the quantum computing system.

3. The method of claim 1, wherein the one or more system parameters comprises at least one of a system setting, one or more limits on the control values, and one or more limits on rates of change.

4. The method of claim 1, wherein the one or more control values comprises at least one of a laser frequency, laser intensity, laser phase, and ion-motion coupling parameter.

5. The method of claim 1, wherein the one or more noise offsets comprises at least one of a system offset, time-dependent offset, stochastic error, dephasing, and crosstalk.

6. The method of claim 1, wherein the properties comprise at least one of a laser frequency, intensity, and phase associated with the at least one of the candidate pulses.

7. The method of claim 1, wherein the one or more pulses comprises one or more frequency-modulated pulses.

8. The method of claim 1, wherein the quantum computing system is a trapped ion quantum computing system.

9. A computer-readable storage medium storing a plurality of instructions, which, when executed by one or more processors, causes a quantum computing system to:
generate, based on a specification of one or more system parameters, one or more control values, and one or more noise offsets, a controlled environment for a quantum computing system;
simulate, as a function of the control values, one or more pulses within the controlled environment;
identify, based on an evaluation of the simulated pulses, one or more candidate pulses; and
return a sequence comprising properties of at least one of the one or more candidate pulses.

10. The computer-readable storage medium of claim 9, wherein the plurality of instructions, when executed, further causes the quantum computing system to:
generate, from the returned sequence, the at least one of the one or more candidate pulses within the quantum computing system.

11. The computer-readable storage medium of claim 9, wherein the one or more system parameters comprises at least one of a system setting, one or more limits on the control values, and one or more limits on rates of change.

12. The computer-readable storage medium of claim 9, wherein the one or more control values comprises at least one of a laser frequency, laser intensity, laser phase, and ion-motion coupling parameter.

13. The computer-readable storage medium of claim 9, wherein the one or more noise offsets comprises at least one of a system offset, time-dependent offset, stochastic error, dephasing, and crosstalk.

14. The computer-readable storage medium of claim 9, wherein the properties comprise at least one of a laser frequency, intensity, and phase associated with the at least one of the candidate pulses.

15. The computer-readable storage medium of claim 9, wherein the one or more pulses comprises one or more frequency-modulated pulses.

16. The computer-readable storage medium of claim 9, wherein the quantum computing system is a trapped ion quantum computing system.

17. A quantum computing system comprising:
one or more processors,
a memory storing a plurality of instructions, which, when executed by the one or more processors, causes the quantum computing system to:
generate, based on a specification of one or more system parameters, one or more control values, and one or more noise offsets, a controlled environment for a quantum computing system;
simulate, as a function of the control values, one or more pulses within the controlled environment;
identify, based on an evaluation of the simulated pulses, one or more candidate pulses; and
return a sequence comprising properties of at least one of the one or more candidate pulses.

18. The quantum computing system of claim 17, wherein the one or more system parameters comprises at least one of a system setting, one or more limits on the control values, and one or more limits on rates of change.

19. The quantum computing system of claim 17, wherein the one or more control values comprises at least one of a laser frequency, laser intensity, laser phase, and ion-motion coupling parameter.

20. The quantum computing system of claim 17, wherein the one or more noise offsets comprises at least one of a system offset, time-dependent offset, stochastic error, dephasing, and crosstalk.
